(19) United States
(12) Patent Application Publication
(10) Pub. No.: US 2012/0000473 A1
(43) Pub. Date: Jan. 5, 2012

(54) MASK

(76) Inventors: Nobuo Shigematsu, Tokyo (JP); Kenichi Ono, Saitama (JP); Shuichiro Shimada, Saitama (JP); Yusuke Takayama, Saitama (JP)

(21) Appl. No.: 13/138,612

(22) PCT Filed: Sep. 30, 2009
(86) PCT No.: PCT/JP2009/067445

§ 371 Date: Sep. 9, 2011

(30) Foreign Application Priority Data
Mar. 12, 2009 (JP) 2009-59307
Mar. 12, 2009 (JP) 2009-59308

(51) Int. Cl. A62B 18/02; A41D 13/11

(52) U.S. Cl. 128/863; 128/206.19

(57) ABSTRACT

Provided is a mask which can be folded small and has improved portability and storability. A mask which can be folded small characterized in that, as FIG. 1 shows, a filter part, which comprises single or multi layered filter material and provides a rectangular section at the center when folded in two along the center line, is provided; triangular filter parts, each having the major side of the rectangular filter part as the bottom side, are formed in an integrated manner in the longitudinal direction of the rectangle, and tightening strings are attached to the respective minor sides of the rectangular filter part. A mask comprising a mask main body which has the center line matching the nosal bridge and is provided with cover sheets being positioned in the right and left sides thereof and covering around the nose, mouth and jaw, and tightening strings attached to the side edges of the right and left cover sheets respectively, characterized in that a stretchable rubber string is attached to the tope edges of the right and left cover sheets nearly orthogonally to the nosal bridge line. This mask can be discarded without separating and the pressing force thereof to the vicinity of the nose never weakens with the passage of time.

### FIELD OF THE INVENTION

The present invention relates to a mask used for medical use, food hygience use, ordinary industrial use, pollenosis protector use, infection prevention use or sanitary use in common life, specifically, the present invention relates to a mask whose adhesion to nosal region, where is difficult part for adhering the mask perfectly to face of a user, further, the present invention relates to a small foldable mask whose portability and storability are improved.

### DESCRIPTION OF PRIOR ARTS

There are two types of mask in mask used in ordinary industrial use. That is, one is a type that a mask main body (filter) is cap shape type and another one is a foldable shape type. As a cap shape type mask, for example, as shown in FIG. 8, there is a mask characterized that a shape retentioning device 3 is inserted along with joining part 5 of outer periphery of mask main body (filter) 1 and outer periphery of face contact cloth 4 (for example, refer to JP2003-320041 publication: Patent document 1). And as an improvement of said art, in Patent document 2 (JP2006-305279 publication), following art is disclosed. That is, a mask characterizing that a metal part such as soft aluminum is stuck to a sheet shape filter, especially, around nosal region having violent ups and downs, the metal part is fitted to nosal region of each user by bending the metal part. However, in this case, each user must bent the metal part by himself or by herself so as the mask to fit the face shape (shape of nosal region), but this work is difficult and cannot be easily fitted. If bending is loose, the mask cannot fit to face, and if bending is too much, the mask cannot fit to face too. Further, this mask is used as a cheap mask such as disposal dustproof mask or other simple mask, and because metal part is used, it is necessary to remove this metal part when the used mask is thrown away. This is recognized as a troublesome problem. Recently, a mask which uses a flexible shape support device made of polyolefin synthetic resin which provides a shape supporting function instead of metal (patent document 3) is proposed, however, this mask has problems that the shape support device is an expensive material and holding power of the mask looses along with lapse of time. Although these masks have an advantage of easily maintaining opening between facial region of a user and a filter, there are problems in portability and storability.

As a foldable mask, for example, a mask shown in FIG. 10 can be indicated, however, projection area when this mask is folded is not so small and maintenance of opening between facial region is difficult.

### Prior Arts

### Patent Documents

Patent Document 1: JP2003-320041 publication

Patent Document 2: JP2006-305279 publication

Patent Document 3: JP2006-43227 publication

### BRIEF SUMMARY OF THE INVENTION

### Object of the Invention

The present invention relates to a mask which improves above mentioned defects. Specifically, the present invention proposes a small foldable mask characterized that separation of metal part is not necessary at throw away process, adhesion of the mask to both sides of nose where easily forms openings is improved by using a cheap material that holding power of the mask at nosal region is not weakened by lapse of time, packing volume of one mask is small so as portability of the mask to be improved, opening between the mask and facial region can be easily maintained and breathing of a user is easy.

### BRIEF ILLUSTRATION OF THE INVENTION

The essential point of the present invention is illustrated as follows. That is, in a mask which adjusts center line of the mask main body with a line of nosal crest, covers nosal region, oral region and around jaw with a coating sheet extending to right and left directions and provides with a fastening string at side periphery parts of said coating sheet extending to right and left directions, the mask is characterized that a rubber string having elasticity is provided with on upper periphery of right and left sides of coating sheet so that said rubber string crosses with the line of nosal crest. Further, the present invention is a small foldable mask comprising, a rectangular shape filter part which is formed at center part when single or multi laminated layered filter is folded in two along with the center line, a triangle filter part using major side of the rectangular shape filter part as bottom side of the triangle filter part is formed in an integrated manner in longitudinal direction of the rectangular shape filter part and a fastening band is provided with at shorter side of said rectangular shape filter part. Further, in these masks, it is desirable to form beams by fusing and hardening sides which link intersections of the rectangular shape filter part and the triangle filter part formed in longitudinal direction of the rectangular shape filter part with the center point of faced side of the triangle shape filter part. By forming said beams, the mask can be fold easily in rectangular shape.

### Effects of the Invention

Since the mask of the present invention is composed of single material without using metal part or synthetic resin such as polyolefin, separation of metal part is not necessary at throw away process. Further, since the mask uses cheap material such as elastic rubber string, adjusting manipulation is not necessary, and adhesion of the mask to nosal region can be improved while not weakening holding power of the mask along with lapse of time. Furthermore, as a mask, by forming a triangle filter part using major side of the rectangular shape filter part as bottom side of the triangle filter part in an integrated manner in longitudinal direction of the rectangular shape filter part, it becomes easy to maintain an opening between filter of a mask and facial region and assure easy breathing. And, since the mask can be folded small in rectangular shape, it can be contained in purse or in pocket by folded state and is effective for portability.

### BRIEF ILLUSTRATION OF DRAWINGS

FIG. 1 is a plan view of the mask of this invention when the mask is folded along center line

FIG. 2 is a developed plan view of the mask shown in FIG. 1

FIG. 3 is side view showing the wearing state of the mask

FIG. 4 is an illustrating view showing the folding processes of the mask for carrying with or packaging

FIG. 5 is an elevational view of another example of the mask of this invention

FIG. 6 is a perspective view showing wearing state of the mask of FIG. 5

FIG. 7 is a side view showing wearing state of the mask of FIG.

FIG. 8 is a back perspective view of conventional cap shape mask

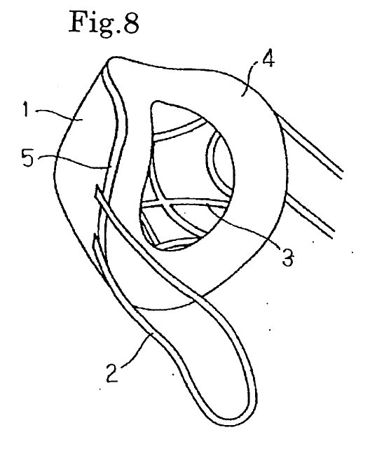

FIG. 9 is a conventional cap shape mask, (a):elevational view (b):side view

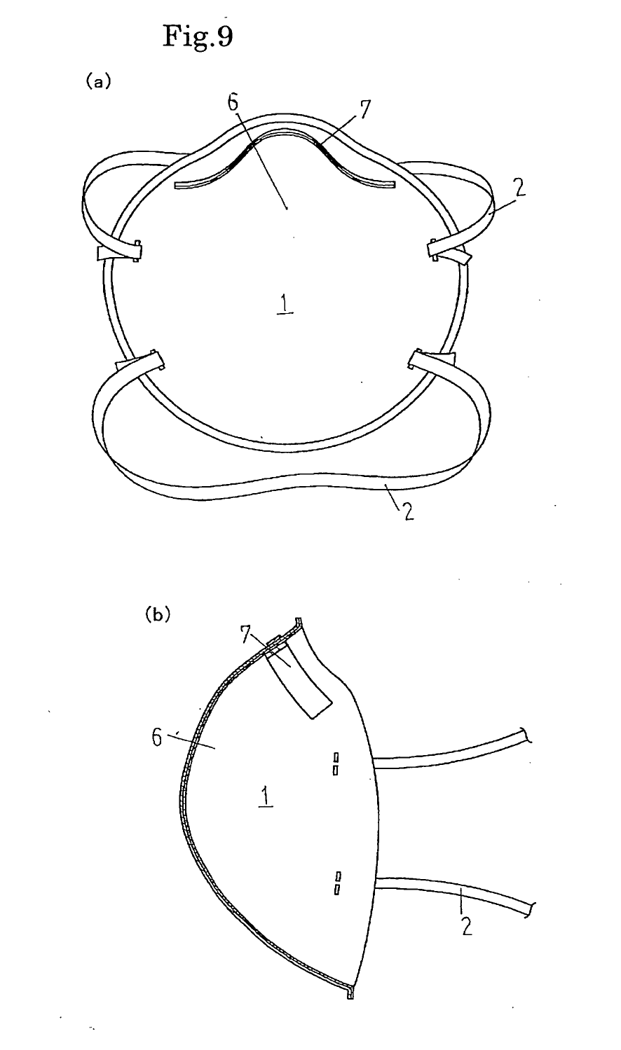

FIG. 10 is a side view showing folded state of conventional foldable mask

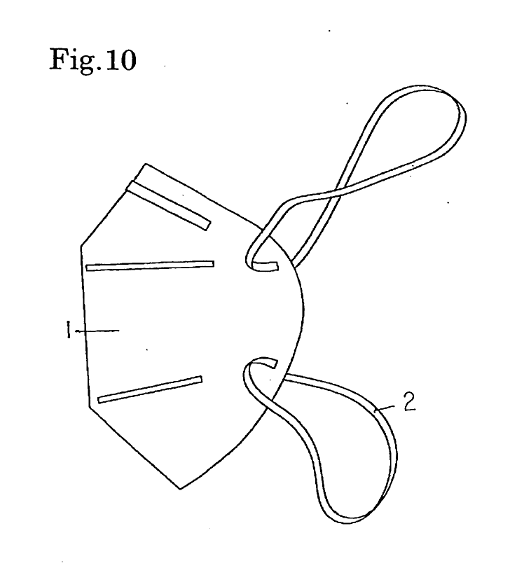

### PREFERRED EMBODIMENT OF THE INVENTION

The present invention will be illustrated in detail.

As a filter which can be used in the present invention, materials such as non woven cloth or gauze which are used as a filter of conventional mask can be mentioned. Single or multi layered filter prepared by laminating these filter materials are used, and these filters are fused and adhered to necessary part or are cut and fabricate a mask of the present invention. At the fabrication process, a side connecting a peak of rectangular shape filter part and a center point of faced side of the triangle shape filter part formed in longitudinal direction is fused and hardened so as to form a beam, then the shape of said mask as is can be maintained easily, further the mask can be folded compact to rectangular shape.

Further, the mask relating to the present invention composes the mask main body by a filter such as gauze or non woven cloth, center line of said mask main body is adjusted to nosal crest, and nosal region, oral region and around jaw are covered with a coating sheet extending to right and left directions, and a fastening string is provided with at both side periphery parts of the coating sheet. And in the mask of the present invention, a rubber string having elasticity is provided with on upper periphery of right and left side of coating sheet so that the rubber string crosses with the line of nosal crest and by draw said coating sheet of right and left side to center direction of face so that the mask fits to nose which locates at center of face and to uneven surface neighboring to nose.

In the worn state of such kind of mask, it is desirable to form a fused line beam across from upper peak and bottom peak of center convex part of the mask to about center of upper side and lower side of the coating sheet extended to right and left direction. By forming said beam, the mask can maintain shape along with concave shape of nosal region at actual use, further, when it is not used, because it is easy to be fold compact, namely thinner and flat, storing of it is not so hard and can be hold in a purse or in a pocket.

### EXAMPLES

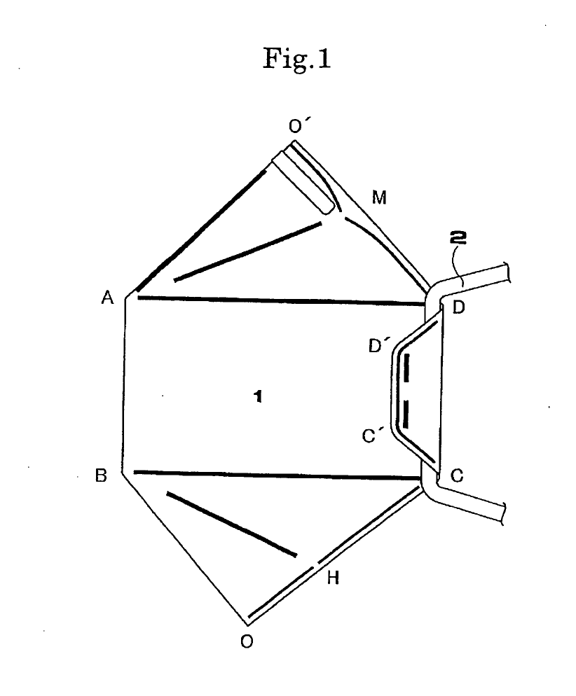

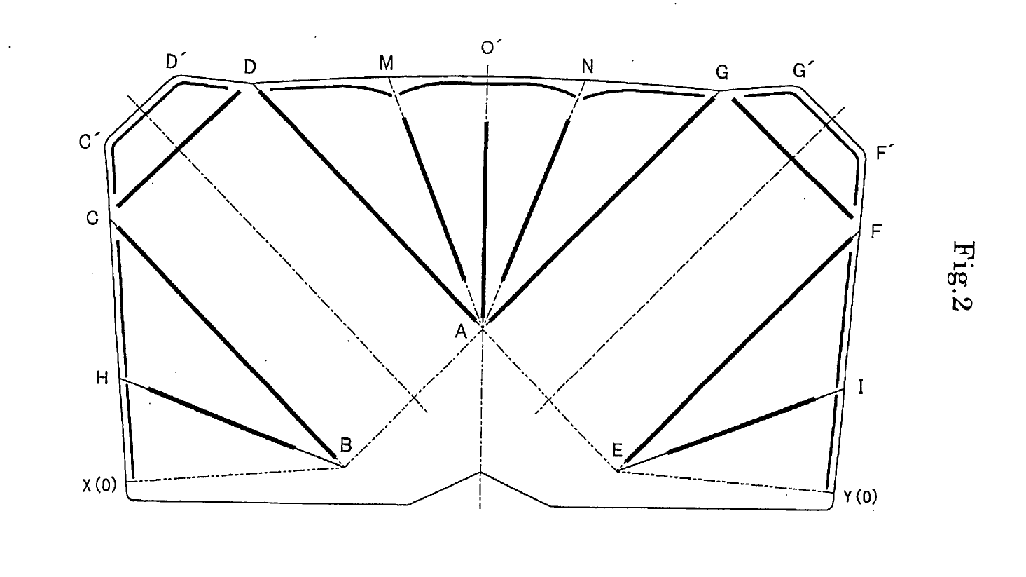

The shape of the mask of the present invention will be illustrated concretely along with drawings. FIG. 1 shows the state that the mask of the present invention is folded in two, and FIG. 2 is a developed plan view illustrating structural feature of the mask. As shown in FIG. 2, rectangular filter material is cut to shape of outline surrounded by points of A, B, X, H, C, C′, D′, D, M, O′, N, G, G′, F′, F, I, Y, E and A, folded to two along with center line AO', lines of AB, AE, BX and EY are fused, C′D′ and G′F′ are respectively bended to inside along with CD and GF lines accordingly penetrated passages are formed. By installing a fastening string to the penetrated passages, folded state to two of the mask is formed as shown in FIG. 1. A point where X and Y are overlapped each other is set up as O. And by hardening every side by i.e. ultrasonic welder, processes for folding and developing of the mask become easy. Further, by hardening lines from A to M and N, which are locating almost center point of DO′ and O′G in faced side, and lines from B to H and I, which are locating almost center point of CO and OF in faced side, by i.e. ultrasonic welder and forming beams, maintaining action of the mask three dimensionally or folding action of the mask compact become more easy.

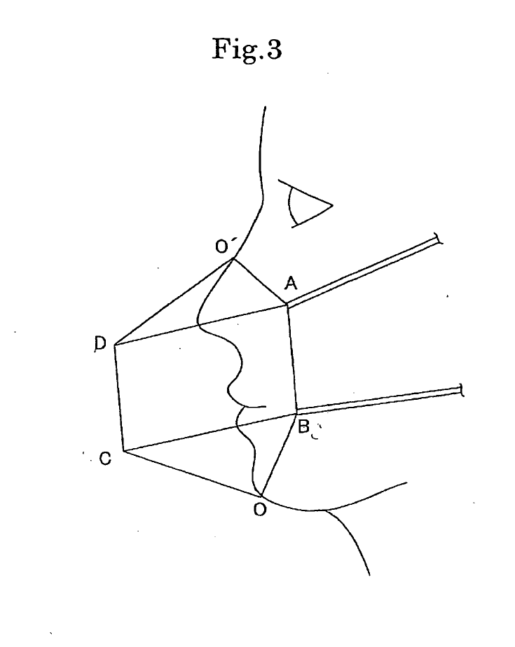

At the actual wearing of the mask, meet O′O line of mask to nosal crest of face, develop the mask to right and left direction along with facial region and put the fastening string over head, thus nosal region and oral region can be covered by the mask. AM and AN act as creases to make the mask follow to concave region of both side of nose, AD, BC and AG, EF act to maintain three dimensional shape to cover nose of a user and BHOIE meets to outline of jaw. Side view of the mask at the actual wearing is shown in FIG. 3.

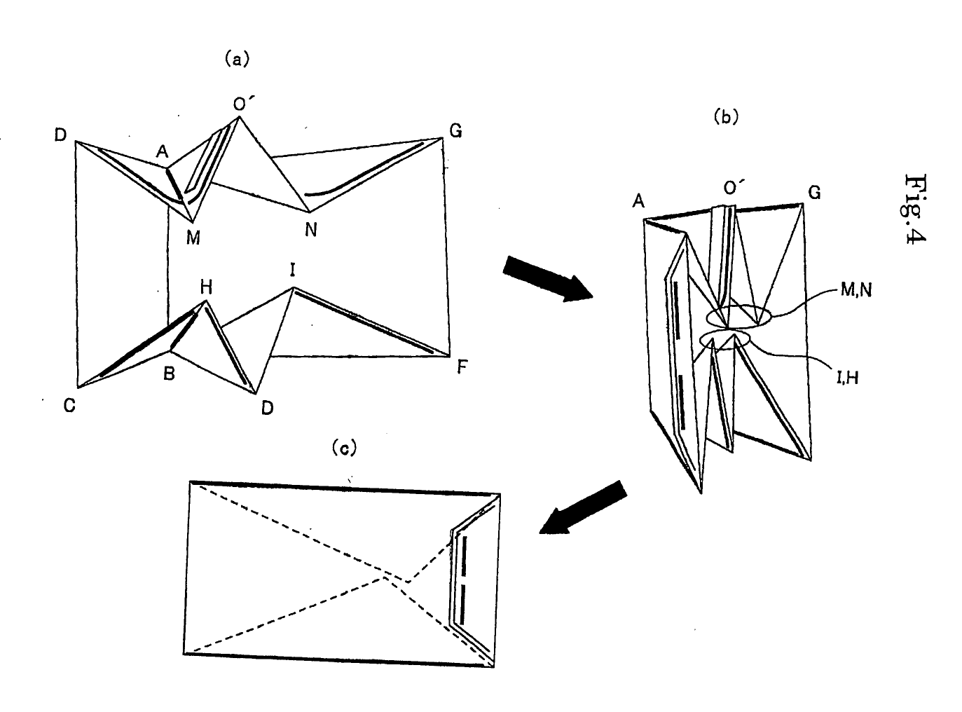

Folded states of the mask of the present invention when it is packed or carried with are shown in FIG. 4(a)-FIG. 4(c). FIG. 4(a) shows state of actual wearing of the mask of the present invention. In these drawings, parts relating a fastening string are abbreviated. After actual use, in FIG. 4(a), the mask is folded to inside setting AM and AN as folding lines of valley side, AD, AO′ and AG are overlapped to one line. Same as above, BC, BF and BO are overlapped to one line. At the folding action, the mask can be folded thinner by not to overlap M, N and H, I. Outline of the folded mask as mentioned above is a rectangular parallelpiped shape of ABCD, and idleless shape can be obtained.

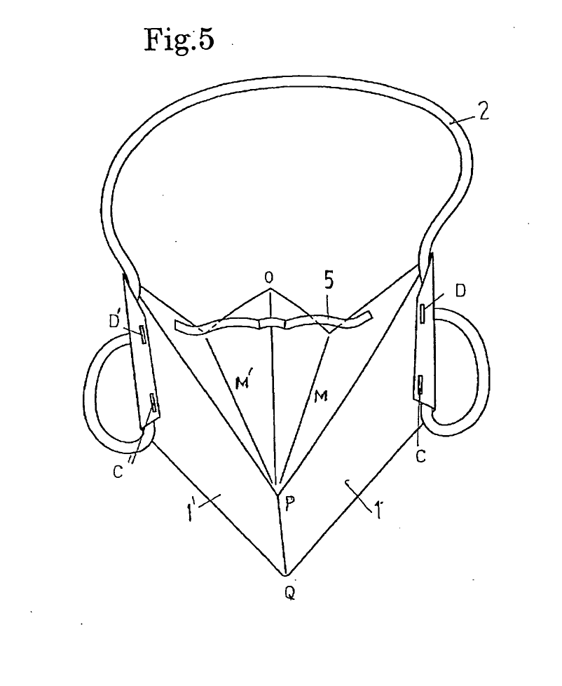

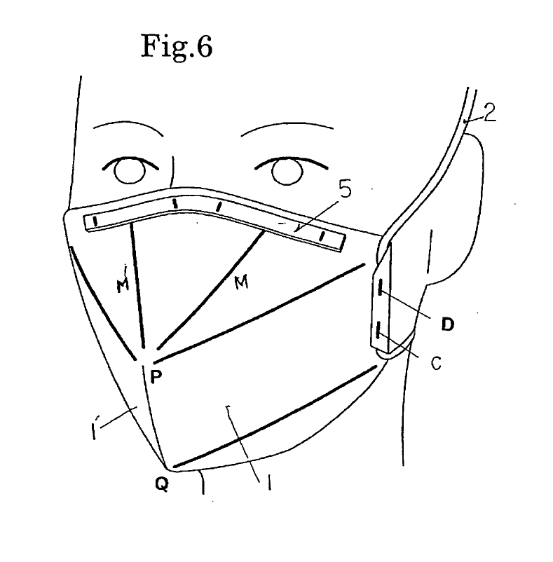

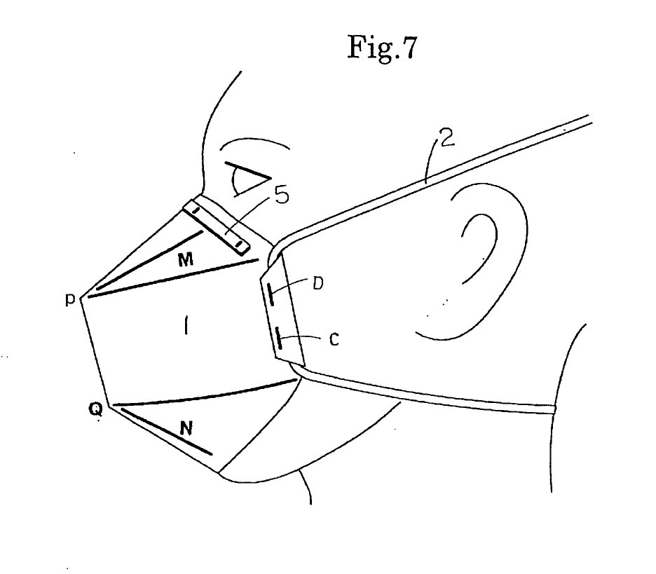

Further, FIG. 5 is an illustraton of the mask of the present invention. As shown in FIG. 5, center line OO′ is formed at center of the mask and coating sheet 1, 1′ which covers face is developed to right and left direction. An elastic rubber string 5 is provided with on upper periphery of coating sheet 1, 1′ so that crosses with the center line OO′. End of the rubber string 5 is provided with to the coating sheet 1, 1′ by being stretched state so as the coating sheet of right and left to stretch to center part. And, a fastening string installing part 3, 4 and 3′, 4′ are formed on side periphery parts of the coating sheet of right and left. Then, put the fastening string 2, 2′ over head of a user, the coating sheet can cover tightly nosal region, oral region and around jaw by stretching action of above mentioned rubber strings. The perspective view showing the actual wearing state of the mask is shown in FIG. 6, and side view of it is shown in FIG. 7. Further, in FIGS. 6 and 7, by forming fused line beams M, M′ from upper peak P of mask center part to upper periphery of the coating seat, and forming fused line beams N, N′ from lower peak Q of mask center part to lower periphery of the coating sheet, convex shape of nosal region can be easily maintained, further, can be hold thinner, flatter and compact at not wearing time, therefore, the mask can be contained in a pocket or between a notebook.

### INDUSTRIAL APPLICABILITY

The small foldable mask of the present invention is very light weight, and in actual wearing, since opning between face and the mask can be easily secured, breathing becomes easy. And, when the mask is folded, it is not so bulky, therefore it has an advantage that it can be hold, for example, between note book.

And since the mask of the present invention is composed of single material without using metal parts or synthetic resin such as polyolefin, separation throwing away is not necessary. Further, the mask is designed not to weaken holding power at nosal region by time lapse using cheap material such as rubber strings, this mask is useful as a disposable simple mask which can improve adhesion of nosal region.

### Illustration of Marks

A, B, X (O), H, C, C′, D′, D, M, O′, N, G, G′, F, F, I, and Y(O) are peaks of the mask of the present invention.

AM, AN, AD, AG, B(O)C, E(O)F, B(O)H and E(O)I are beams to maintain the mask three dimensionally at actual wearing.

1: mask main body (filter)

2: fastening string

3: shape retentioning device

4: face contact cloth

5: joining part of filter and outer periphery of mask main body

6: center part of nosal region covering part

7: metal of sponge

1, 1′: covering sheet, 2: fastening string,
3,4 and 3′,4′: arranging part of fastening string, 5: rubber string,
P: upper peak, Q: lower peak, M,M′: upper beam, N,N′: lower beam

1. (canceled)

2. A foldable mask comprising, a mask main body comprising a coating sheet possessing a rectangular shape filter part which is formed at center part when single or multi laminated layered filter is folded in two along with the center line, a triangle filter part using major side of said rectangular shape filter part as bottom side of the triangle filter part which is formed in an integrated manner in longitudinal direction of said rectangular shape filter part, wherein the mask main body is adjusted witha line of nosal crest of a user, nosal region, oral region and around jaw are covered with the coating sheet extending to right and left directions and fastening strings are provided with at side periphery parts of said coating sheet extending to right and left directions, further, an elastic rubber string is provided with on upper periphery of right and left sides of the coating sheet so that said rubber string cross with the line of nosal crest.

3. The mask of claim 2, wherein sides, which link intersections of the rectangular shape filter part and the triangle filter part formed in longitudinal direction of the rectangular shape filter part with the center point of faced side of the triangle shape filter part, are fused and hardened and form beams.
